(19) United States
(12) Patent Application Publication
(10) Pub. No.: US 2012/0000570 A1
(43) Pub. Date: Jan. 5, 2012

(54) HOLDING DEVICES AND METHODS FOR USING THE SAME

(76) Inventor: Valentino Foscarota, Somerville, MA (US)

(21) Appl. No.: 12/829,510

(22) Filed: Jul. 2, 2010

(51) Int. Cl. B65B 3/04; F16M 11/14; F16M 11/10

(52) U.S. Cl. 141/2; 248/125.1; 248/124.2

(57) ABSTRACT

The present invention provides holding devices and methods for using the same. One aspect of the invention provides a holding device configured to hold a container having a dose or multiple doses of a liquid medicine with a needle-piercable cap. The holding device includes a holder comprising a split barrel and a base. Another aspect of the invention provides a method of loading a syringe with a liquid medicament held in a container. The method includes: providing a holding device including a holder including a split barrel and a base; mounting the holding device on a surface; placing the container into vial holder; and using two hands to draw the liquid medicament from the vial into the syringe.

### FIELD OF THE INVENTION

The present invention relates to a device for holding medicament containers in a position to aid withdrawal of a liquid medicament into a syringe. In particular, the devices of the present invention include a stable base that can rest on a surface or be attached to a surface to free both hands for operating the syringe.

### BACKGROUND OF THE INVENTION

A significant number of individuals administer subcutaneous injections for therapeutic purposes. For example, a significant portion of the estimated 23 million Americans with diabetes mellitus will self-administer subcutaneous insulin injections at some point.

Referring to FIG. 1, medicaments are often provided in a vial 102. It is often difficult for individuals to safely and accurately fill a syringe 104 with the medicament provided in the vial 102. In order to fill the syringe 104, the individual must hold both the vial 102 and the syringe tube 106 while pulling back on the syringe plunger 108. Care must be taken to avoid aspirating air from the vial 102 into the syringe 104 so as to avoid an air embolism.

U.S. Pat. No. 6,006,798 describes a syringe loading jig that includes a molded jig structure having cavities for the vial and the syringe and securing clips for both, as well as fastening mechanisms for securing the jig to a vertical surface.

U.S. Pat. No. 5,351,866 describes a vial holder having a handle portion adapted to be carried by a human hand and a friction mount for releasably retaining a vial.

U.S. Patent Application Publication No. 2004/004171 describes a safety device for holding a vial or ampule, while a syringe is used to extract liquid medication. The device is held by hand with the vial inserted, thereby permitting the vial to be distanced from the hand holding the vial or ampule.

U.S. Pat. No. 5,240,047 describes a unitary one-piece needle-guide and bottle-holder device.

U.S. Pat. No. 5,247,972 describes an alignment guide for hypodermic syringes.

U.S. Pat. No. 6,497,697 describes a syringe guide and vial holder.

The challenges of holding a vial 102 while loading a syringe 104 are particularly exacerbated in the elderly, many of whom suffer from arthritis, peripheral neuropathies, and/or other conditions that diminish strength, dexterity, and/or fine motor skills.

None of the prior art appear to have solved these challenges. Simple devices and methods to aid individuals in connection with these challenges are still desirable.

### SUMMARY OF THE INVENTION

The present invention provides holding devices and methods for using the same.

One aspect of the invention provides a holding device configured to hold a container having a dose or multiple doses of a liquid medicine with a needle-piercable cap. The holding device includes a holder comprising a split barrel and a base.

This aspect of the invention can have a variety of embodiments. The holding device can include an angular adjustment linkage between the base and the holder.

The linkage can include a ball-and-socket joint.

The base can have a bottom surface that comprises a non-skid material. The non-skid material can be selected from the group consisting of: rubber, polychloroprene, silicone, and polyurethane.

The holding device can include one or more suction cups on the base. The holding device can include a clamp for attaching to a mounting surface.

Another aspect of the invention provides a method of loading a syringe with a liquid medicament held in a container. The method includes: providing a holding device including a holder including a split barrel and a base; mounting the holding device on a surface; placing the container into vial holder; and using two hands to draw the liquid medicament from the vial into the syringe.

This aspect of the invention can have a variety of embodiments. The holding device can include an angular adjustment linkage and the method can include adjusting the angle of the container relative to the mounting surface to facilitate drawing the medicament into the syringe without air. The surface can be selected from the group consisting of: a refrigerator, a cabinet, a countertop, and a table.

Another aspect of the invention provides a holding device configured to hold a container having a dose or multiple doses of a liquid medicine with a needle-piercable cap. The holding device includes a holder comprising a split barrel and a suction cup. The holding device is fabricated from a single piece of material.

This aspect of the invention can have a variety of embodiments. The material is plastic. The material can be rubber.

### FIGURES

For a fuller understanding of the nature and desired objects of the present invention, reference is made to the following detailed description taken in conjunction with the accompanying drawing figures wherein like reference characters denote corresponding parts throughout the several views and wherein:

FIG. 1 depicts an insulin vial and a syringe according to the prior art.

FIG. 2A is a multiview orthographic projection of a vial-holding device including a ball-and-socket joint according to one embodiment of the invention, with vial.

FIG. 2B depicts a vial-holding device including a clamp according to one embodiment of the invention.

FIG. 2C depicts a front elevational view of a device according to another embodiment of the invention having a suction cup.

FIG. 2D provides cross-sectional side view of the vial-holding device of FIG. 2C.

FIGS. 2E and 2F depict the vial-holding device of FIG. 2A with tilted vial and inserted syringe.

FIG. 3 depicts a method for loading a syringe with a substance held in a vial.

FIG. 4 depicts a one-piece vial-holding device.

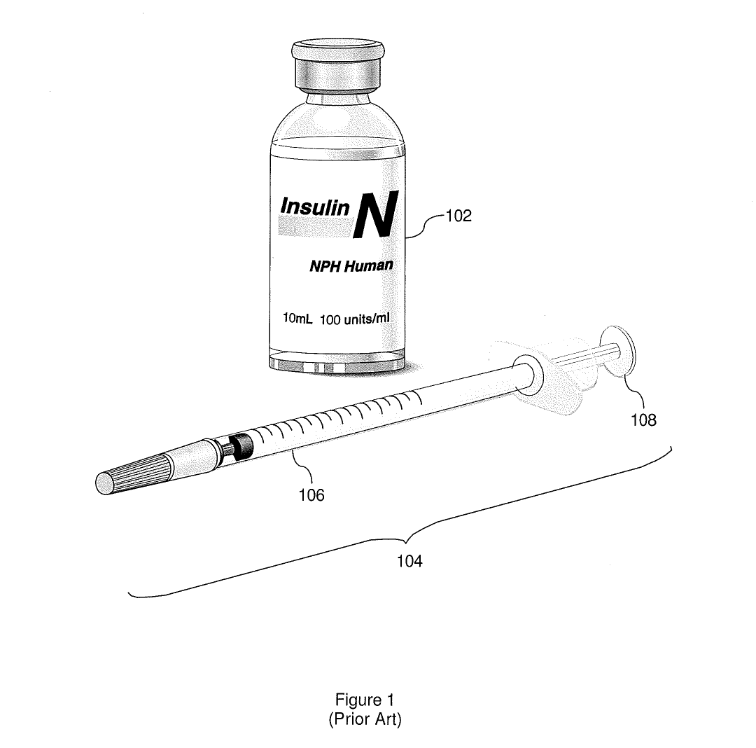

### DETAILED DESCRIPTION OF THE INVENTION

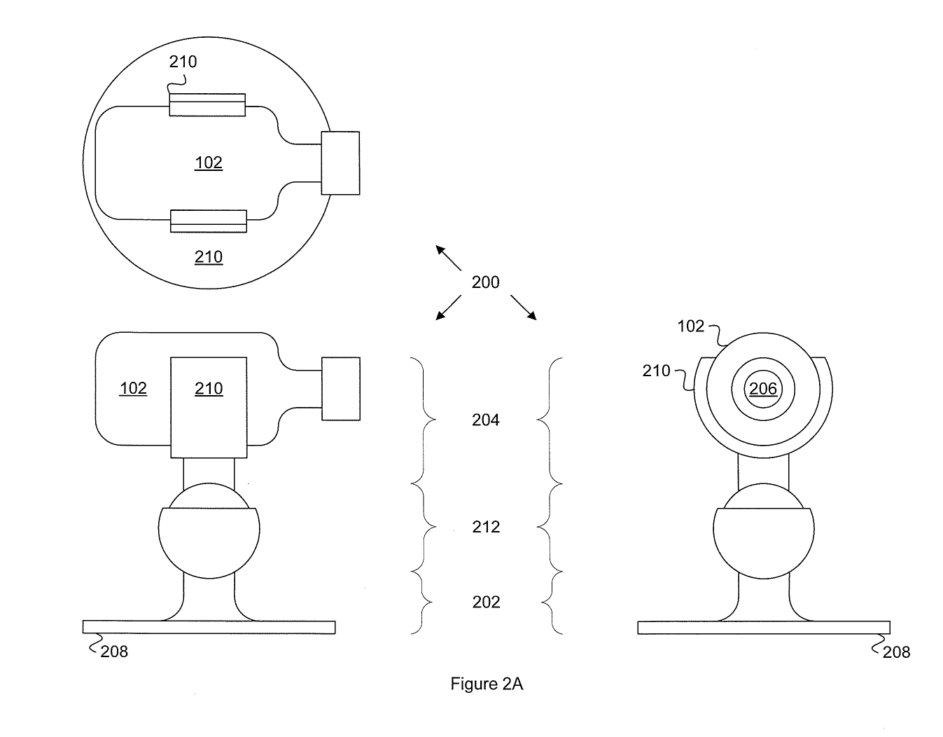

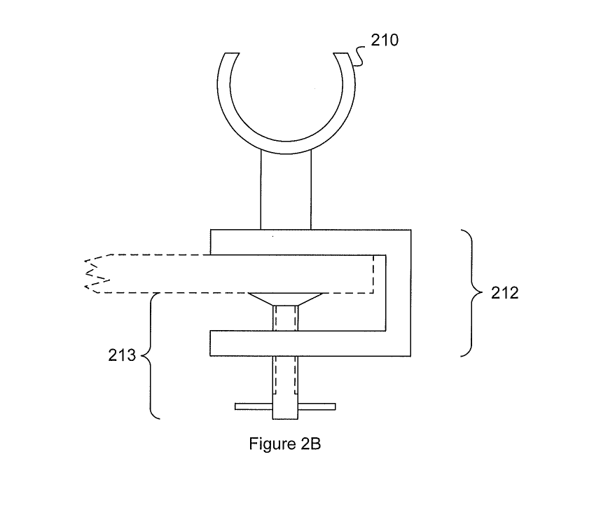

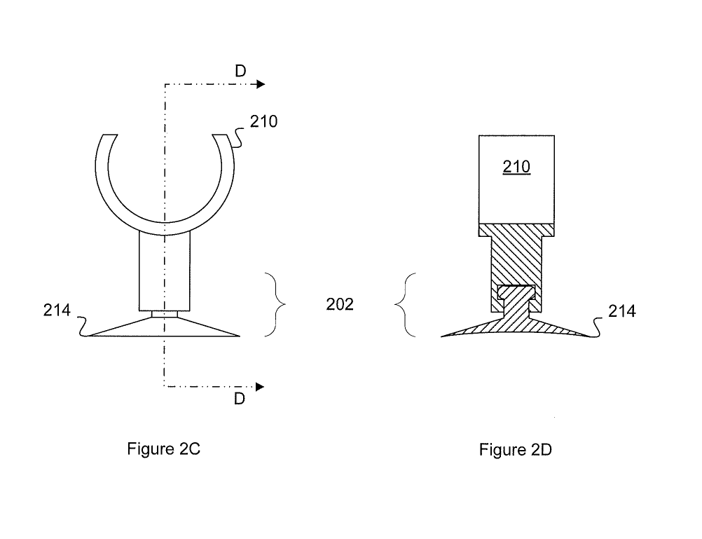

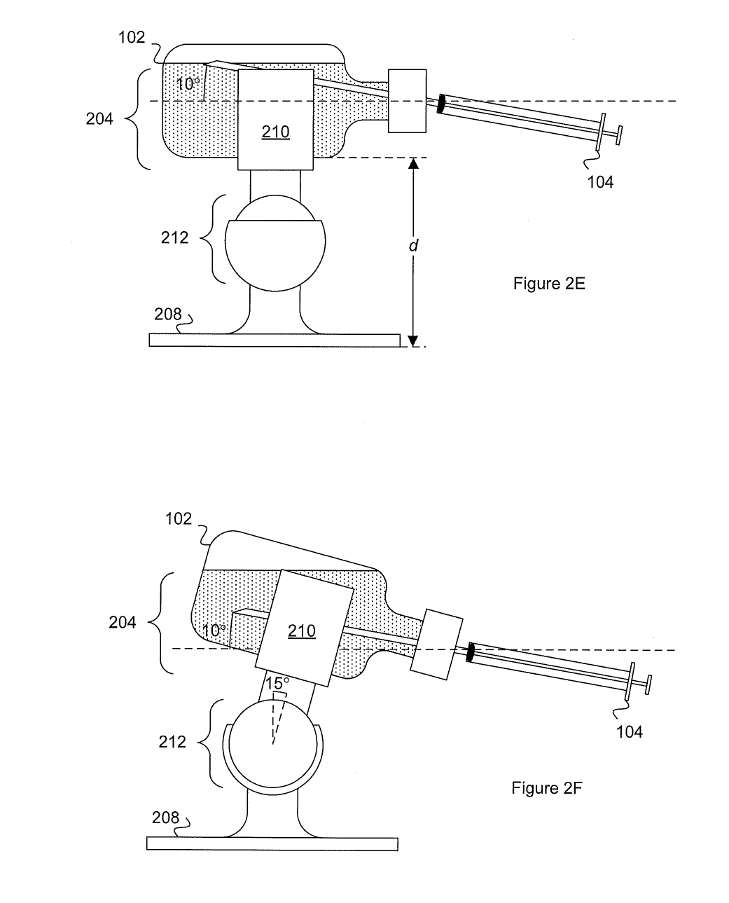

FIG. 2A provides a multiview orthographic projection of a vial-holding device 200 with vial according to an embodiment of the invention. Vial-holding device 200 includes a base 202 and a vial holder 204.

### Base

Base 202 can be any device capable of securing the vial-holding device 200 in a manner sufficient allow for piercing of the septum 206 of the vial 102.

In some embodiments, the base 202 is configured for mounting on a mounting surface such a table, countertop, and the like. In such an embodiment, base 202 can include a substantially flat bottom surface 208. The base is sized and weighted (if necessary or desirable) to provide stability to the vial while manipulating a syringe to withdraw fluid from the vial. Those skilled in the mechanical arts can provide a suitable base.

The base 202 can be made of, or can have attached to the bottom surface 208, a material with a high coefficient of static and/or dynamic friction vis-a-vis surfaces on which the device 200 may be placed (e.g., wood, stone, and the like). Suitable materials with high friction include non-skid polymers such as rubber, polychloroprene (also known as neoprene), silicone, polyurethanes (available, for example, under the SORBOTHANE® trademark from Sorbo, Inc. of Twinsburg, Ohio), and the like. In some embodiments, one or more weights (e.g., lead, rocks, plates, and the like) can be used to apply additional force to surface 208 to limit movement. Such weight can be molded into the base or added to the base in any convenient manner well known to those skilled in the mechanical arts.

In another embodiment depicted in FIG. 2B, one or more clamps 213 can be used to secure base 202 to the mounting surface.

In still another embodiment depicted in FIGS. 2C and 2D, base 202 can be or can be coupled to one or more suction devices 214. Exemplary suction devices 214 include suction cups that are actuated by pressing the suction cup against a mounting surface to displace air between the suction cup and the mounting surface. One embodiment of a suction cup that has been tested successfully has an inner radius of 0.875 inch when looking at a cross-section through the center of the cup.

In yet another embodiment, base 202 can include one or more magnets (not depicted) for mounting on ferrous surfaces.

### Vial Holder

Vial holder 204 is a device capable of holding a vial 102 tightly while a syringe is inserted into the vial 102.

In some preferred embodiments, vial holder 204 includes a split barrel structure 210 that can flex to receive and securely hold vial 102. Although split barrel structure 210 in FIG. 2 typically has an opening of about 120°, one of ordinary skill in the art will appreciate that opening can range from about 0° to a maximum opening that still is capable of frictionally holding the container. The opening of course will depend on the flexibility of the material as well as the friction between the material and the container. For example, opening can be about 0°, about 5°, about 10°, about 15°, about 20°, about 25°, about 30°, about 35°, about 40°, about 45°, about 50°, about 55°, about 60°, about 65°, about 70°, about 75°, about 80°, about 85°, about 90°, about 95°, about 100°, about 105°, about 110°, about 115°, about 120°, about 125°, about 130°, about 135°, about 140°, about 145°, about 150°, about 155°, about 160°, about 165°, about 170°, and about 175° depending on the material used.

A number of other techniques can be used to couple vial 102 with vial holder 204. For example, vial holder 204 can include a strap to hold vial against a surface (e.g., a curved surface). In another example, the vial 102 can include a ferrous material and vial holder can include one or more magnets. In still another example, vial holder 204 and a vial 102 can include corresponding hook-and-loop fasteners (available, for example, under the VELCRO® trademark from Velcro USA Inc. of Manchester, N.H.). Further, other containers for liquid medicaments, such as, e.g., ampules, can also be held by similar holding devices modified to accommodate the container geometry by techniques well known to those skilled in the art.

### Linkages

In some embodiments, vial-holding device 200 includes a linkage 212 for coupling base 202 and vial holder 204. In other embodiments, base 202 and vial holder 204 are formed from single piece of material.

Preferred linkages permit angular rotation of the vial or other container. In one example, linkage 212 is a ball-and-socket joint. Such an embodiment can be a particularly helpful feature for preventing aspiration of air in the vial 102 into syringe 104.

As illustrated in FIG. 2E, if the vial 102 is held horizontally and, if the user angles the syringe 104 even slightly upward, air can be aspirated into the syringe 104, particularly as the substance in the vial 102 is withdrawn.

However, as depicted in FIG. 2F, users of preferred embodiments of the invention can manipulate linkage 212 to angle vial holder 204 and vial 102 so that the liquid in the vial 102 covers the syringe needle during loading. Moreover, if the user angles the syringe 104, the syringe 104 will be less likely to aspirate air.

Although the vial holder 204 is depicted as angled approximately 15° from horizontal, one of ordinary skill in the art will appreciate that vial holder 204 can be adjusted to any desired angle from horizontal depending on the particular adjustable linkage that is used. For example, vial holder 204 can be adjusted to about 0° from horizontal, about 5° from horizontal, about 10° from horizontal, about 15° from horizontal, about 20° from horizontal, about 25° from horizontal, about 30° from horizontal, about 35° from horizontal, about 40° from horizontal, about 45° from horizontal, and the like. Also, the vial-holding device 200 can be mounted on a vertical surface and the vial holder 204 can be positioned at about 50° from horizontal, about 55° from horizontal, about 60° from horizontal, and the like. Also, the holding device can be mounted on a vertical surface and the angular adjustment made from the vertical to aid filling a syringe.

In order to facilitate a desired angle vial 102, vial holder 204 can, in some embodiments, be elevated further from the bottom of base 202. For example, vial-holding device 200 can be configured such the bottom of vial 102 is held any desired distance d from the bottom of base 202. In preferred embodiments, the distance d is approximately the same dimension as the height of the container to be held. Typically, the distance d can be between about 1″ and about 4″. For example, distance d can be about 1″, about 2″, about 3″, and about 4″. However, for particular circumstances, d can be greater; in such cases the base of the device may also need to be larger for stability.

### Materials

One of ordinary skill in the art will appreciate that base 202, vial holder 204, and linkage 212 can be fabricated from a variety of materials including metals, plastics, wood, and the like by use of various manufacturing techniques such as molding, casting, machining, and the like. However, as noted above, when the vial holder provides a friction fit to hold the vial during withdrawing liquid into a syringe, the material must have sufficient flexibility to accommodate the vial and must provide the friction fit either by the material of the holder or a lining material added to the holder.

### Methods of Loading Syringes

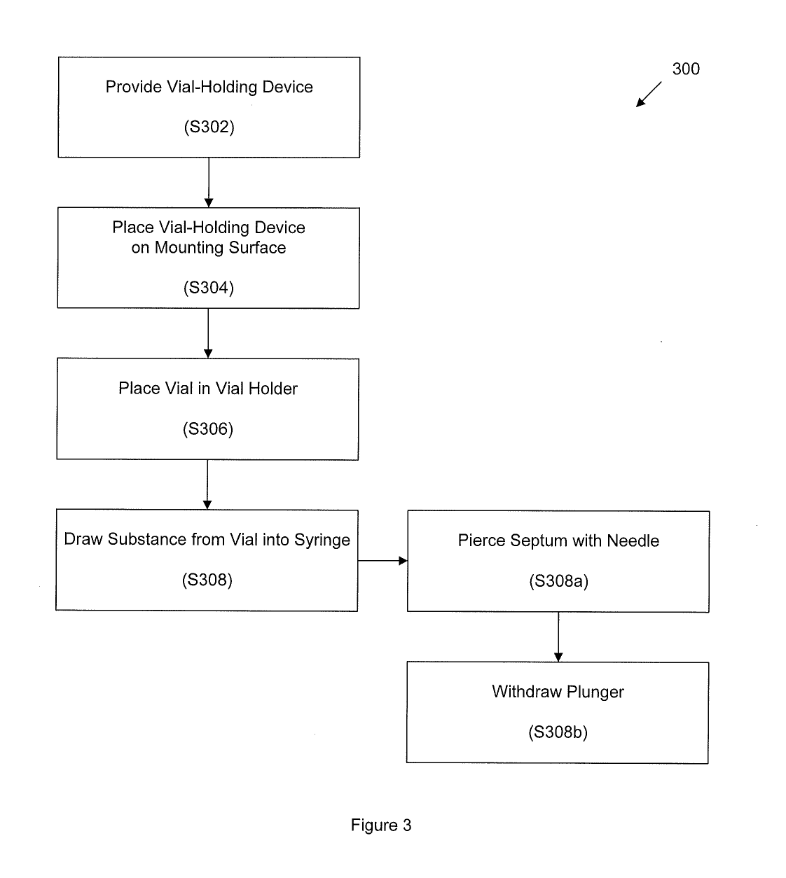

Referring now to FIG. 3, a method 300 is provided for loading a syringe with a liquid substance held in vial or other suitable medicament container.

In step S302, a vial-holding device is provided. The vial-holding device can be one of the embodiments provided herein. For example, the vial-holding device can include a vial holder with a split barrel and a base. In another example, the vial-holding device can include a vial holder that can be adjusted angularly such that when the vial is inserted into the vial holder, the vial can be angled as desired with respect to a horizontal line or a vertical line, depending on the orientation of the surface on which it is mounted.

In step S304, the vial-holding device is optionally placed on mounting surface such as a table, a countertop, a refrigerator door, a cabinet door, and the like.

In step S306, the vial is placed in the vial holder and the angle adjusted with appropriate device holders permitting an angular adjustment.

In step S308, the substance in the vial is drawn from the vial into the syringe using both hands to manipulate the syringe. For example, the vial septum can be pierced with the syringe needle (step S308a). The syringe plunger can then be withdrawn to draw the liquid in the vial into the syringe (step S308b).

### One-Piece Vial-Holding Device

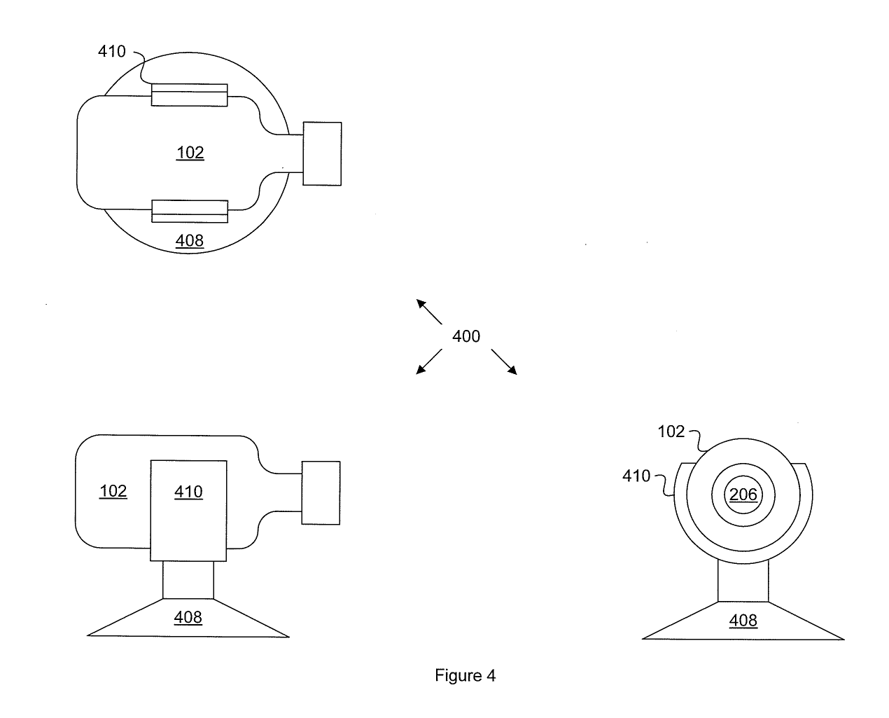

Referring now to FIG. 4, a one-piece vial-holding device 400 is provided. Vial-holding device 400 includes a split barrel structure 410 coupled to a suction cup 408.

Vial-holding device 400 can be fabricated from single piece of material such as plastics, rubbers, metals, and the like by techniques such as molding, casting, machining, and the like.

### Advantages

The vial-holding devices 200, 400 described herein advantageously allow for the use of both hands to pierce the septum 206 of vial 102. Additionally, because the vial-holding devices 200, 400 can be mounted on virtually any surface, a vial 102 can be removed from a refrigerator and immediately placed within a vial-holding device 200, 400 placed on an a refrigerator door or adjacent countertop or cabinet. Thus, the invention reduces the risk of dropping and potentially breaking a vial 102.

### EQUIVALENTS

The foregoing specification and the drawings forming part hereof are illustrative in nature and demonstrate certain preferred embodiments of the invention. It should be recognized and understood, however, that the description is not to be construed as limiting of the invention because many changes, modifications and variations may be made therein by those of skill in the art without departing from the essential scope, spirit or intention of the invention. Also, various combinations of elements, steps, features, and/or aspects of the described embodiments are possible and contemplated even if such combinations are not expressly identified herein.

### INCORPORATION BY REFERENCE

The entire contents of all patents, published patent applications, and other references cited herein are hereby expressly incorporated herein in their entireties by reference.

1. A holding device configured to hold a container having a dose or multiple doses of a liquid medicine with a needle-piercable cap, the holding device comprising:
a holder comprising a split barrel; and
a base.

2. The holding device of claim 1, further comprising an angular adjustment linkage between the base and the holder.

3. The holding device of claim 1, wherein the linkage comprises a ball-and-socket joint.

4. The vial-holding device of claim 1, wherein the base has a bottom surface that comprises a non-skid material.

5. The holding device of claim 4, wherein the non-skid material is selected from the group consisting of: rubber, polychloroprene, silicone, and polyurethane.

6. The holding device of claim 1, further comprising one or more suction cups on the base.

7. The holding device of claim 1, further comprising a clamp for attaching to a mounting surface.

8. A method of loading a syringe with a liquid medicament held in a container, the method comprising:
providing a holding device including:
a holder including a split barrel; and
a base;
mounting the holding device on a surface;
placing the container into vial holder; and
using two hands to draw the liquid medicament from the vial into the syringe.

9. The method of claim 8, wherein the holding device further comprise an angular adjustment linkage and the method further comprises adjusting the angle of the container relative to the mounting surface to facilitate drawing the medicament into the syringe without air.

10. The method of claim 8, wherein the surface is selected from the group consisting of: a refrigerator, a cabinet, a countertop, and a table.

11. A holding device configured to hold a container having a dose or multiple doses of a liquid medicine with a needle-piercable cap, the holding device comprising:
a holder comprising a split barrel; and
a suction cup,
wherein the holding device is fabricated from a single piece of material.

12. The holding device of claim 11, wherein the material is plastic.

13. The holding device of claim 11, wherein the material is rubber.
